(19) United States
(12) Patent Application Publication
(10) Pub. No.: US 2003/0101060 A1
(43) Pub. Date: May 29, 2003

(54) Use of historical data for a voice application interface

(76) Inventors: Corine A. Bickley, Somerville, MA (US); Allan E. Brockenbrough, S. Hamilton, MA (US); Erin M. Panttaja, Somerville, MA (US)

Correspondence Address: Thomas M. Sullivan, Esq., Mintz, Levin, Cohn, Ferris, Glovsky and Popeo, P.C, One Financial Center, Boston, MA, 02111, US

(21) Appl. No.: 09/997,298

(22) Filed: Nov. 29, 2001

(51) Int. Cl. G10L 21/00; G10L 11/00

(52) U.S. Cl. 704/275

(57) ABSTRACT

A method, apparatus and system are provided for using the historical data of a user of an application, such as a voice application, to provide to a user a more effective user interface. The present invention can allow a system to automatically provide a user of a voice application with an application service based upon the user's prior activity in the application. In one embodiment, the method includes providing a user with an interface to access the voice application and to invoke one of a plurality of application services; selecting an application service for the user, without the user requesting the application service, as a function of information representative of the user's past access to the application; and providing the selected application service to the user.

### FIELD OF THE INVENTION

The present application relates generally to a system and method for using historical data for the operation of a voice application. More specifically, it relates to a system and method for using a user's historical data to provide a more effective user interface for a voice application.

### BACKGROUND OF THE INVENTION

Users of most voice applications typically speak commands or ask questions in order to obtain a service or data from a voice application. Once the user speaks a command to request a service, the application will attempt to recognize the user's command using voice recognition. If the application can recognize the user's command, it will provide the requested service to the user.

A user, however, may have difficulty in using an interface for a voice application. One possible difficulty is that the user may forget a specific command that is needed to obtain a particular service. Another possible difficulty is a voice application at times may not correctly recognize the user's command. Yet another possible difficulty is that a user may find it cumbersome to repetitiously speak the same command. Therefore, it is desirable to provide a voice application system having a more effective user interface such that it can effectively provide services to a user with less effort and concentration on the part of the user.

### SUMMARY OF THE INVENTION

In accordance with the invention, a method and system are provided for using the historical data of a user of an application, such as a voice application, to provide a user with a more effective user interface. The present invention can allow a system to automatically provide a service to a user of a voice application based upon the user's prior activity in the voice application. In one embodiment, the method includes providing a user with an interface to access the voice application and to invoke one of a plurality of application services; selecting an application service for the user, without the user requesting said application service, as a function of information representative of the user's past access to the application; and providing the selected application service to the user.

The present invention can involve a system-initiated action that can include providing information or invoking an action without the user needing to provide input, which can reduce the cognitive load on the user. The voice application can play information and perform actions that are likely to be desired by the user and can allow the user to cancel if she wants the system to be quiet, or to say something specific if she wants a different system action.

When using a voice personal assistant that involves information retrieval, users may form patterns of usage, such as always asking for the weather or for a particular stock quote. In order to make the voice application easier to use, the present invention can provide commonly requested information by default, instead of waiting for the user to speak specific commands.

The present invention can improve the quality of interaction between a user and a voice application by making use of historical information relating to the access, usage or usage patterns of a user. To accomplish this, information relating to the person's usage patterns is collected. This collected information can include the types of commands used, time of use, called party, frequency of use, utilization of web/internet information, and geographical location (i.e. the physical location or the telephone number from which the user placed the call). The data can be analyzed to find specific user patterns relating to the invocation of commands in the user interface and frequency of usage of commands. This information can then be used to improve the interaction between the user and a system such as one that includes a voice personal assistant.

In accordance with the present invention, any application, such as a voice application, can be modified to initiate an action in the absence of user input. The initiated action may be to invoke a system service that historically is known to be frequently invoked based on a pattern of user activity (e.g. weather information is requested every morning between 8:00 a.m. and 8:30 a.m.). Alternatively, the initiated action may be a system service that has not been used recently, if ever, for the purpose of introducing the service to the user or of reminding the user about a service. In another embodiment of the invention, if the voice application fails to match the user's speech with a predefined grammar within an acceptable threshold, then the system can use historical patterns of user interaction to select a closest match to the user's speech.

### BRIEF DESCRIPTION OF THE DRAWINGS

FIG. 1 is a block diagram of the system for using historical data in a voice interface in accordance with the invention.

FIG. 2 is a more detailed block diagram of the server of FIG. 1

FIG. 3 is a user data log showing data associated with a user's commands used with the system of FIG. 1.

FIG. 4 is an exemplary table showing a schedule of predicted user activity used with the system of FIG. 1.

FIG. 5 is an exemplary table showing a log of the user's commands that were used with the system of FIG. 1.

FIG. 6 is an exemplary table showing counts of a user's selection of each service with the system of FIG. 1.

FIG. 7 is an exemplary table of activity types and variations in the system of FIG. 1.

FIG. 8 is an exemplary last usage table used with the system of FIG. 1.

FIG. 9 is a flowchart for using historical data in a voice interface for the system of FIG. 1.

### DETAILED DESCRIPTION OF THE INVENTION

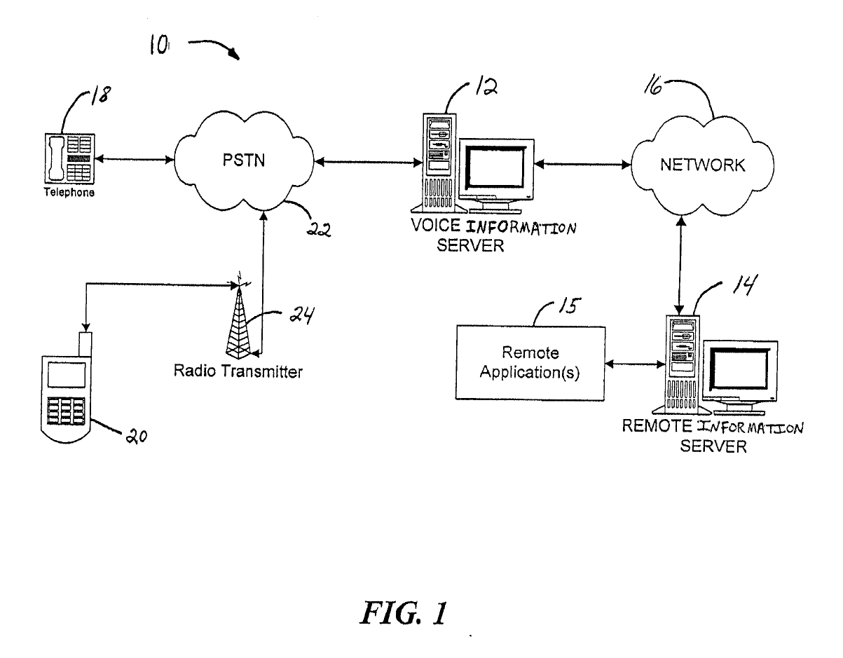

FIG. 1 shows a view of a voice information system 10 in accordance with the present invention. The system 10 can include a voice information server 12 coupled to one or more remote information servers 14 via a network 16, such as the Internet, and coupled to one or more terminals, such as a telephone 18 and a mobile telephone 20 via a network 22, such as a public switched telephone network (PSTN). The mobile telephone 20 can connect to the network 22 through a wireless network connection 24, such as a radio transmitter. The remote information server 14 can be adapted for storing one or more remote applications 15 in a storage device (not shown). The remote application 15 can be any application that a user can interact with using voice or DTMF (touch tone) commands, either directly or over a network. The remote application 15 or an application on the server 12 can operate using any programming language that will allow a user to provide vocal input to the remote application, such as, but not limited to, VoiceXML, HTML, Java, or a C program connected to a voice recognition engine, or other software. Also, the remote application need not use voice or DTMF; the server 12 may translate a text or GUI-based remote application 15 for use with voice.

The network 16 can be a public data network such as the Internet or a private data network. Alternatively, the voice information server 12 and the remote information server 14 can be separate applications that are executed on the same physical server or cluster of servers and communicate with each other over an internal data connection. It is not necessary for the invention that the remote information server 14 be used or connected via a network to the voice information server 12.

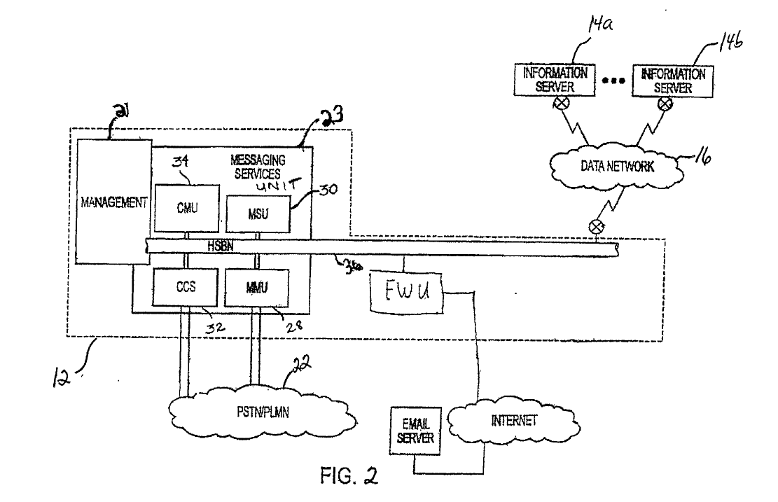

FIG. 2 shows a more detailed view of the voice information server 12. In a preferred embodiment, the information server 20 is the TRILOGUE Infinity system manufactured by Comverse Network Systems, Inc. of Wakefield, Mass. However, it should be understood that the present invention is not limited to a voice personal assistant operating within an information server, nor is it limited to information servers having the architecture illustrated in FIG. 1. For example, the present invention may also use the Access NP system manufactured by Comverse Network Systems, Inc. of Wakefield, Mass.

Referring to the example of FIG. 2, the major components that may be included in the information server 12 include a management unit 21 and a messaging services unit 23, which can provide voicemail and facsimile, as well as unified messaging services, such as e-mail and short message services. The management unit 21 controls the operation, configuration, monitoring, provisioning, and administration for the server 12. The messaging services unit 23 can be a voice controlled unit that is composed of a plurality of multi-media units (MMUs) 28 that are connected to voice trunks in the PSTN/PLMN 22. The MMUs can perform voice signal processing functions for a plurality of messaging and storage units (MSU), such as one or more MSUs 30 or Natural Language Units (NLUs) which can store subscriber history and records and host application software. The host application software can include software for the present invention and the Tel@Go personal assistant application by Comverse Network Systems, Inc. of Wakefield, Mass. In addition, the MSUs 30 can store various system and custom prompts that the information server 12 uses for its various functions and services.

The one or more MMUs 28 can reside on one or more computers each controlled by a single or multiple microprocessors. The one or more computers can include a Pentium-based computer manufactured by Comverse Network Systems, Inc., with 1 MB memory, 4 GB system disk storage, that includes one or more network interface cards and voice processing cards. The MSU 30 can be a similar computer having up to 18 GB additional storage for private subscriber information including personal address books. A call control server (CCS) 32 interfaces with call signaling trunks, such as SS7, system message desk interface (SMDI), etc., in the PSTN/PLMN 22 to provide information on a user's calling number and location. The CCS 32 may be a Pentium-based computer made by Ulticom Corp. of Mount Laurel, N.J., that includes one or more network interface cards. Overall control of messaging services can be performed by a central management unit (CMU) 34 that is connected to the MMUs 28, the MSUs 30 and the CCS 32 by a high-speed backbone network (HSBN) 36, such as a switched Ethernet supporting 10 Base T or 100 Base T. The CMU 34 may be an Alpha-based computer made by Compaq of Houston, Tex., with interfaces to the HSBN 36 as well as to a host management computer (not shown) of the network operator.

When a subscriber calls the information server 12, the call goes through the PSTN/PLMN 22 and reaches an MMU 28 which can interact with the subscriber's record stored on the subscriber's home MSU 30.

The MSUs 30 are capable of playing any one of a number of individual audio passages to a user or subscriber in the form of prompts. These prompts are used with respect to a variety of different types of services which are provided by the information server 12. The prompts can invite a user to either enter keystrokes on the telephone or to provide a voice response.

Software stored on server 12 and/or used with embodiments of the present invention can be stored on computer usable medium for storing data, such as, for example, but not limited to, Magnetic Media (removable disks and tapes, fixed or hard drives), optical media (CD ROM, CD-R, DVD) and solid state media (flash memory, memory cards and sticks).

In accordance with the present invention, the system can detect patterns of usage, such as a user invoking a command (an application service, such as, a request for information, place a call, etc.) in an application, such as a voice application or a voice personal assistant. The server 12 can detect these patterns by examining the attributes relating to where or when the command was performed. Possible attributes of a user command used to predict user activity can include the time of day, the day of week, whether it's a weekend or weekday, location, or a combination of these.

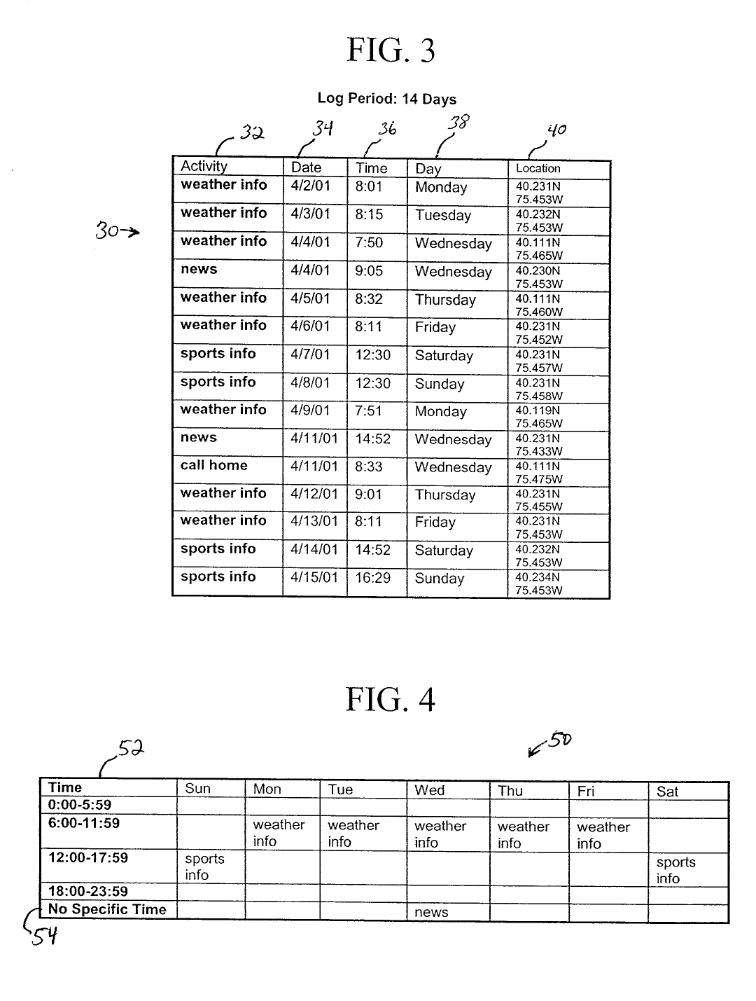

In accordance with the invention, the patterns of user activity can be determined by collecting user activity data, storing the data, such as in a log, and then analyzing the data. FIG. 3 shows an exemplary user data log 30 for a specific user or set of users. The data log for example, can include the activity or command 32 the user invoked, the date 34, the time 36, the day of the week 38 and the location 40 of the user at the time the user specified the command. For example, in FIG. 3, a user requested to hear weather information on Monday, Apr. 2, 2001 at 8:01 a.m. and was at the coordinates of 40.231 North and 75.453 West at the time of the call.

The data log 30 can have a predetermined configurable length. The data log 30 can have a predetermined number of entries or be kept for a predetermined number of days or another time period. For example, the data log 30 can represent a period of 14 days. The maximum number of records or days to be maintained in the data log 30 can depend on many factors, such as, the desirability of knowing the user's past commands, limits on available disk space, and/or the desirability of knowing only the user's most recent commands for flexibility in recognizing new user behaviors. Preferably, the data log 30 is maintained in a first in, first out (FIFO) queue such that older records are deleted as newer records are entered. The data log 30 preferably contains user commands that were fully executed and not commands the user cancelled.

The data log 30 provides the data which the system can analyze in order to detect one or more patterns of usage. Examples of patterns of usage that can be determined include:

Activity <f> is performed every day at time <t>;
Activity <f> is performed every weekday at time <t>;
Activity <f> is performed on every <d> at time <t>;
Activity <f> is performed every day;
Activity <f> is performed every weekday;
Activity <f> is performed on every day <d>;
Activity <f> is performed at a specific location <l>;
Activity <f> is performed at a specific location <l> every day <d>

at time <t>;

Activity <f> is performed at a specific location <l> every weekday

at time <t>;
where

<f> = activity
<t> = time of day
<d> = day of the week.
<l> = location

In one embodiment, the time attributes can be considered with respect to predefined time periods or periods of the day, rather than considering precise moments in time. For example, the 24 hours in the day can be broken into 4 six-hour periods.

The data log 30 can be analyzed to determine patterns of usage. In one embodiment of the invention, for each activity, the number of times the activity occurs is divided by the number of possible times for the activity to occur during the log period. If this value exceeds a threshold, then the system can consider the data to represent a pattern of usage.

For example, consider the data log 30 shown in FIG. 3 and the pattern of a user requesting the activity ‘weather info’ every weekday between 6:00-11:59 a.m. In this example, data log 30 includes 10 weekdays in a 2 week period. The probability of “weather info” matching this above pattern is: the number of times “weather info” is performed on a weekday between ‘6:00-11:59’ divided by 10, which equals 8/10 or 80% (since “weather info” was selected eight out of ten possible times). If 80% is above the predetermined threshold, the server 12 may consider this percentage to represent a user pattern.

Note that in the preferred embodiment, for any given weekday at a specific time interval, only one occurrence of the activity is counted. In other words, if on a given day, the user requests the weather twice between 6:00 and 11:59, the server 12 will only count this activity once. Alternatively, each occurrence can be counted in a specific time period.

In accordance with the present invention, patterns that have probability greater than a given threshold can be used to construct a schedule of predicted activity 50 for the user as shown in FIG. 4. The schedule 50 includes a plurality of daily time periods 52 including 0:00-5:59, 6:00-11:59, 12:00-17:59, and 18:00-23:59. Using the data from the data log 30 of FIG. 3 and an exemplary threshold of 75%, the user's likely patterns of usage are:

Activity “weather info” is performed every weekday between “6:00-11:59.”

Activity “sports info” is performed every weekend between “12:00-17:59.”

Activity “news” is performed every Wednesday.

In one embodiment of the invention, the server 12 can give users the ability to view and edit the predicted behaviors, predicted schedule of activity and/or whether or not they would like to receive predicted activities. Additionally or alternatively, a user can edit the predetermined length of the data log 30, which can include the number of days records are kept or the number of entries. Preferably, the user can edit the predicted behaviors or predicted schedule of activity using the Internet. A user could also perform the same edits over a telephone that has a connection to server 12.

Some patterns may be considered subsets of other patterns. For example, if a pattern is established that an activity is done every weekday between 6:00 and 11:59, then, by definition, this pattern encompasses that the activity is done every Monday between 6:00 and 11:59. Preferably, but not necessarily, high order patterns take precedence over lower order patterns. In general, a pattern for one activity having a higher order than a second pattern will be presented to a user first if the server has the option to present an activity to a user for both the first and the second pattern. For example, a pattern such as selecting “weather information” every weekday may have a higher order than selecting “Comverse stock quote” on Tuesday.

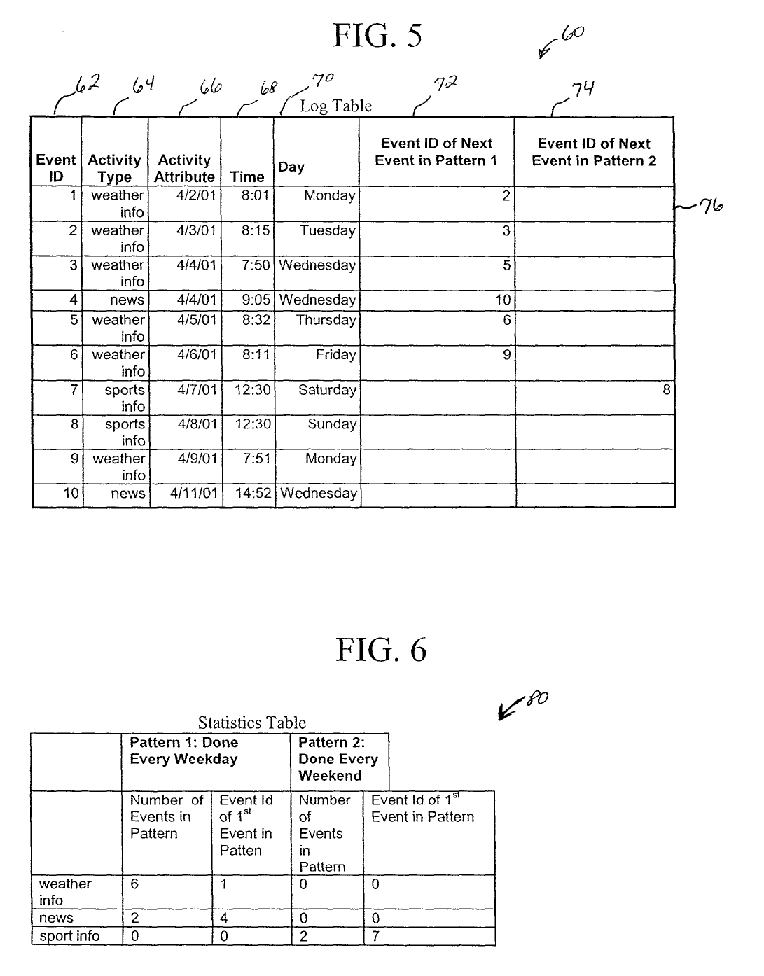

FIGS. 5 and 6 show an exemplary implementation of the algorithm for determining patterns of activities according to the invention. Other implementations should be readily apparent to those skilled in the art.

As shown in FIGS. 5 and 6, the log information can be stored in two database tables. Referring to FIG. 5, the first table 60 contains a row for each command successfully used in the system. By a “successful use” it is meant that the action was initiated (either automatically or by the user), and was not subsequently cancelled. Each row contains a unique event identification 62, the activity type 64, any relevant activity attributes 66, such as a time, location or name from an address book, and other attributes such as when the activity was performed (which can include the time 68, day 70 or part of week) and the location where the activity was performed. This table can also contain a column for each potential pattern of usage. In the example below, “Pattern 1” in column 72 refers to a pattern that the activity is done every weekday. “Pattern 2” in column 74 refers to a pattern that the activity is done every weekend. All events that are related in a pattern in a particular column are preferably linked together. For example, for event identification 1 in row 76, the next event in pattern 1 is event identification 2. The patterns shown in FIGS. 5 and 6 are exemplary and are not meant to be limiting.

The second database table 80 shown in FIG. 6 contains counts of occurrences of the activity matching specific patterns. There is a row for each type of activity and a column for each potential pattern of usage. For each combination of pattern activity in the table 80, there are two values: (1) the number of events which have occurred within that pattern and (2) the event id of the first of those events. For example, in the table 80, the event of the user asking for the weather occurred six times as part of the “done every weekday” pattern and the event identification of the first event in the log is 1.

Like the data log 30, the table 60 has a configurable maximum length. Preferably, at predetermined intervals, such as either the end of the user's call, during overnight maintenance, or at some other interval, the log length is checked. If the event log 60 is longer than the desired length, events are removed using a predetermined algorithm.

In one such algorithm of removing a record from table 60, the earliest recorded event is removed. For each pattern in the table 60 this event is recorded in, the counter in the Statistics Table is decremented by one, and the pointer is changed from pointing to the event to pointing to the next event in the pattern. For example, if the server 12 removes event id 1 in FIG. 5 for “weather info,” the number of events in the pattern in FIG. 6 is decreased from 6 to 5 and the id of the first event is changed from 1 to 2. In the example of FIGS. 5 and 6, the event ids are part of the event record and thus don't change.

The location of a user can also be used by the system to predict activity. Location data can be provided by a global positioning satellite (GPS) device, the location of a cell tower or PCS satellite through cell tower triangulation, or any other method for identifying location. For each geographical area such as a location cluster, which can be a collection of location points, a separate schedule of activities can be produced showing patterns of user activity. These schedules can be separately maintained in addition to the overall schedule that is not location specific. When a user calls in, the schedule for the current location can be determined. If, at that location cluster, a user's prior usage of a specific voice application service is above a predetermined level, this service can then be provided to the user. The overall schedule (that is not location specific) can also be examined and if a prior activity for a time period is above a predetermined threshold, this activity can be invoked as well. The predetermined threshold for location can be the same or different for the predetermined threshold for time periods. If the server 12 has the option of providing one or more services to a user, the server can provide these services arbitrarily to the user.

As an example, consider a user that performs voice application commands in his office over the course of a week. It is unlikely that the location coordinates for these activities will be precisely the same. In order to use location information, the location data points are preferably organized by areas, called clusters.

At predetermined intervals, the system can compute and re-compute the location cluster. This is done by creating a list of all the locations in the log database, which can be on the order of 1000. For each point in this list, the system computes the distance to each other point. The location data may be stored using a hash table or other storage mechanism between updates.

If the data consists of longitude (lon) and latitude (lat) stored in radians, the distance between two points can be obtained from the equation:

Exact distance in miles = 3963 * arccos[sin(lat1) *

sin(lat2) + cos(lat1) *
cos(lat2) * cos(lon2 − lon1)]

This equation can be obtained from Meridian World Data website at http://www.meridianworlddata.com/DistanceCalculation.asp. Distances for other data formats can be readily determined by those skilled in the art.

In one embodiment of defining location clusters, the distances between location points are checked to find any two points with a distance of less than a system defined variable Q. The variable Q can be 100 meters or any other distance chosen as desirable. The first such pair is put in a list, and all points within Q of either of these two points is added to the list. This process can be repeated recursively until all of the points within Q of any point in the cluster have been added to the cluster. Then another point not in the initial list within Q of another point can be found. This can be repeated until all points not already in a list are at least Q from each other. The last points can form the final cluster. Alternatively, or as an additional datapoint, the location data can consist of the telephone number from which a user called.

In one embodiment of the invention, when the user calls into the system, it examines the predicted activity schedule such as the table 50 in FIG. 4 to see if the user has previously used a specific service during prior occurrences of that time period more than a predetermined threshold, which can be a number or percentage of times. If a specific activity has been invoked by a user above a predetermined threshold for the time period, such as in table 50, then this activity is automatically invoked. Alternatively or additionally, the server 12 can examine the location of the user to determine a service to automatically provide to the user. If no activity is listed for the specific time period or location, then the server can invoke a service if it is listed for no specific time period such as a service not previously used or a new service. Once the server 12 has automatically invoked a service during a time period, preferably the server will not invoke the same service again for another call in the same occurrence of the time period.

Once the server 12 determines that it will invoke a service for a user, it does so automatically. The command is preferably invoked prior to the user giving any initial command. If the user cancels the automatically invoked command, the server 12 can decrease the probability of the pattern by a predetermined fixed amount.

Predicted activity information can also be used when the user pauses during a voice application session. Typically a voice portal session will wait a specified interval for a user utterance before playing a recording prompting the user to speak. Instead of prompting the user, the voice portal session can examine predicted activity information to automatically invoke a frequently used command or provide information about services not previously used or new services available.

The server 12 can also use the table of predicted activity 50 to assist in recognizing and responding to a user command. When a user speaks to a voice personal assistant, occasionally the server 12 fails to acceptably match the user's utterance to a predetermined grammar. In this case, a system may typically make a best guess at what the user intended. Usually, this is the closest match in the grammar to the user's utterance.

The knowledge of a user's patterns of activity, however, can be used to influence the best guess. For example, suppose a user requests weather information 60% of the time when calling on a weekday between 4 pm and 5 pm. Although the 60% may not be great enough for the system to automatically issue a weather command when the user calls in at that time, this information could be used if the user's utterance is not matched. This information is preferably used to bias the voice recognition, not replace it. If the user's utterance match to any grammar is lower than a predetermined percentage, then the weather information request could become the best guess. In that case, the system can either prompt the user whether she would like to hear the weather or simply provide the weather information.

Additionally or alternatively to providing a predicted service to a user, the server 14 can also provide a service that may be new to the user. When the user pauses, the system can analyze the list of available services according to various criteria in order to decide which to offer or introduce to the user. The services can include commands, such as playing newscasts or forwarding mail, or other services, such as barge-in, “cancel,” or requests for help. The criteria used for sorting could include new services, services frequently used by other users, services selected as “important” by system designers, and those services a service provider wants to emphasize. After sorting, a help message can be selected to play to provide the user information about the service.

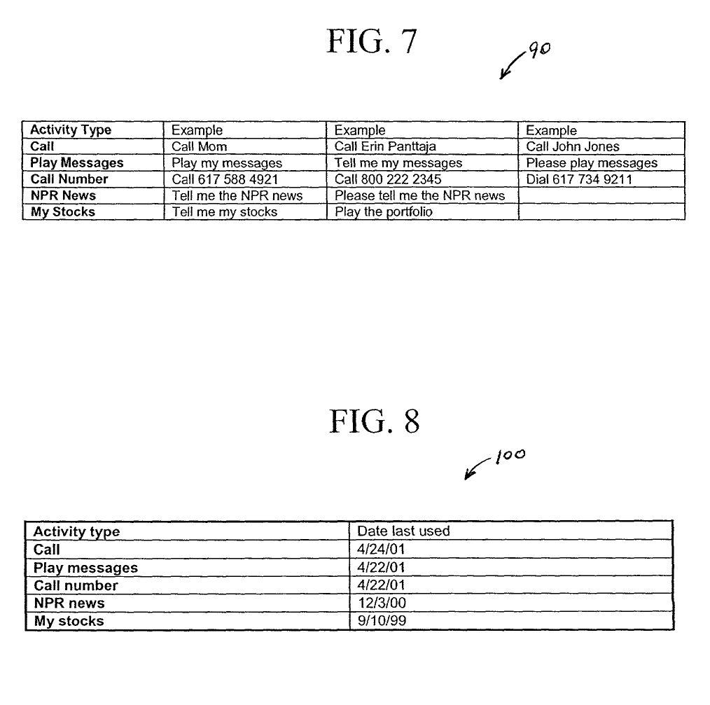

FIG. 7 shows some exemplary variations of user commands that the server 12 can consider to be the same. For example, the server can consider the commands “Play my messages” and “Tell me my messages” to be the same.

In accordance with the present invention, a method and/or system can be provided for determining the least frequently used command as shown with reference to FIG. 8. To determine what service the user has not used recently, the server 12 can maintain a last usage table 100 such as that shown in FIG. 8 which contains one row for each type of activity during one call or user session. The table preferably includes each type of command, but not variations such as those shown in FIG. 7. At the end of a call or a user session or in real time, a table 100 such as the one in FIG. 8 can be updated. The table is updated with the date that the user last used the activity as shown in FIG. 8.

In one embodiment of the invention, at 5 pm each weekday, Sam calls his wife from his office to let her know he's on his way home. The server 12 determines the pattern relating to the user's physical location, time of day, weekday and calling home. After entering the voice portal at 5 pm from his office on Monday, the server 12 automatically asks Sam if he'd like to call home: “Welcome to Tel@Go. Would you like to call home?” Thus, once the voice application detects a calling pattern, the voice application can suggest the placing of the call, or the invoking of a service, for the user without the user having to ask the voice application.

In another example of an embodiment of the invention, at the end of the day, Sam always uses the stock quoting service of the voice portal to get the current stock price of CMVT. The server 12 analyzes the user's usage of the stock quoting service to determine the pattern of the time of day and the request of the stock quote. After entering the voice application, the server 12 automatically provides the quote to Sam without being asked: “Welcome to Tel@Go. The current price of CMVT is $150/share.” Thus, once the voice application detects a pattern of information retrieval, it can provide the information to the user as soon as the user dials in.

In yet another example of an embodiment of the invention, Sam frequently uses the voice application all the time for dialing and stock quotes. One day when he pauses trying to remember a command, the voice application says “You can also say ‘tell me the NPR News.’ ‘This is NPR News. Today, a plane crashed while attempting to land at Mexico City . . . ’” Thus, the voice application can also provide a suggestion to the user about how to ask for a specific service.

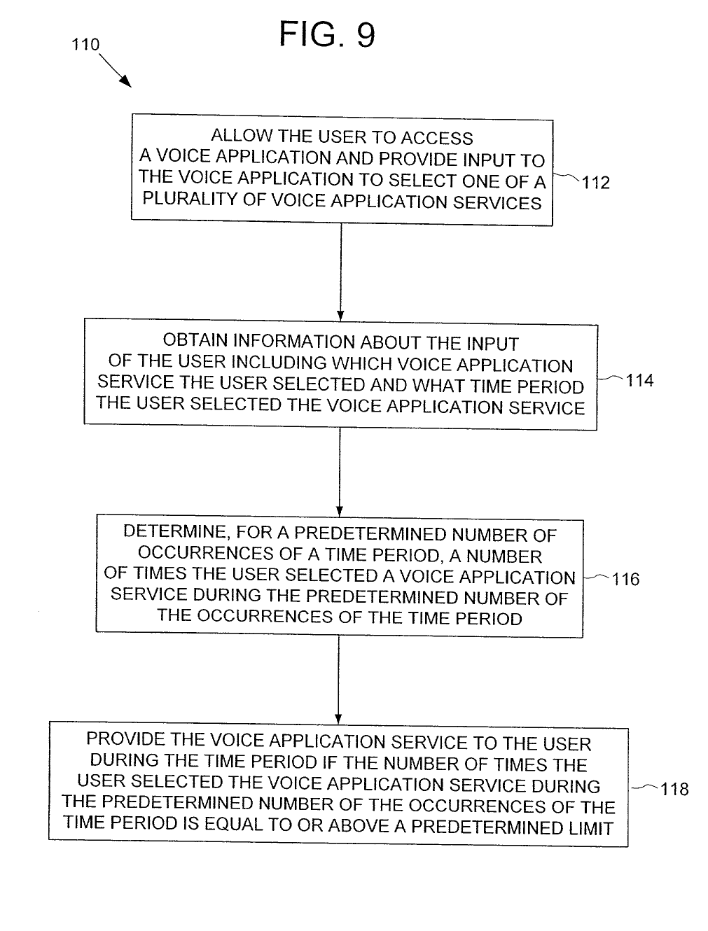

FIG. 9 shows a flowchart for a method for using the historical data of a user in a voice application to provide a user with a more effective user interface. At step 112, the user is allowed to access the voice application and provide input to the voice application to select one of a plurality of voice application services. At step 114, information is obtained about the input of the user including which voice application service the user selected and what time period the user selected the voice application service. Additionally or alternatively to obtaining information about the time period the user selected the voice application, the information obtained can include the location of the user, or other information. At 116, it is determined, for a predetermined number of occurrences of a time period, the number of times the user selected a voice application service during the predetermined number of the occurrences of the time period. For example, if a user accesses a voice application during the 6 a.m. to 11:59 a.m. time period, a server can determine how many times the user selected a particular service (or any of its services), during the last fourteen days in the 6 a.m. to 11:59 a.m. time period. At 118, the voice application service is provided to the user during the time period if the number of times the user selected the voice application service during the predetermined number of the occurrences of the time period is equal to or above a predetermined threshold. For example, if the user selected a particular service in 12 out of the 14 prior time periods, or about 87% of the time, this particular service can be provided to the user if the percentage of about 87% or 12 out of 14 is above a predetermined threshold.

Having thus described at least one illustrative embodiment of the invention, various alterations, modifications and improvements will readily occur to those skilled in the art. Such alterations, modifications and improvements are intended to be within the scope and spirit of the invention. Accordingly, the foregoing description is by way of example only and is not intended as limiting. The invention's limit is defined only in the following claims and the equivalents thereto.

What is claimed is:

1. A method for providing a user an interface to a voice application, the method comprising the steps of:
providing a user with an interface to access the application and to invoke one of a plurality of application services;
selecting an application service for the user, without the user requesting said application service, as a function of information representative of the user's past access to the application; and
providing the selected application service to the user.

2. A method according to claim 1, wherein the information representative of the user's past access to the application includes an identifier associated with a service provided by the application.

3. A method according to claim 1, wherein the information representative of the user's past access to the application includes a time that the user requested the service.

4. A method according to claim 1, wherein the information representative of the user's past access to the application includes a date that the user requested the service.

5. A method according to claim 1, wherein the information representative of the user's past access to the application includes a location from which the user requested the service.

6. A method according to claim 1, wherein the step of selecting an application service for the user, comprises:
determining, for a predetermined number of occurrences of a time period, a number of times the user selected an application service during the predetermined number of the occurrences of the time period; and
selecting the application service if the number of times the user selected the application service during the predetermined number of the occurrences of the time period is equal to or above a predetermined threshold.

7. A method according to claim 6, wherein selecting the application service comprises selecting an application service if a ratio of the number of times the user selected the application service during the predetermined number of occurrences of the time period to the number of times the user could have selected the application service during the predetermined number of occurrences of the time period is equal to or above a predetermined threshold.

8. A method according to claim 6, farther comprising, for each time period, counting more than one occurrence that the user selected the application service as only one occurrence.

9. A method according to claim 6, wherein the selected application service is the application service that the user accessed most frequently during the predetermined number of occurrences of the time period.

10. A method according to claim 6, further comprising:
creating a plurality of time periods wherein each day includes more than one time period.

11. A method according to claim 6, further comprising:
creating a plurality of time periods wherein each week includes a weekday time period and a weekend time period.

12. A method according to claim 11, wherein creating a plurality of time periods further comprises creating a plurality of time periods wherein each day includes more than one time period.

13. A method according to claim 6, further comprising:
ranking each of the time periods by priority such that if a user selected a service at a time within two different time periods and one of the two time periods has a higher priority, a pattern for the one of the two time periods having the greater priority is considered first.

14. A method according to claim 1, further comprising:
allowing the user to view and modify the information representative of the user's past access to the application.

15. A method according to claim 6, further comprising:
recognizing the input of the user to provide a speech recognition;
determining an accuracy of the speech recognition;
wherein providing the application service to the user comprises providing the application service to the user during the time period if the number of times the user selected the application service during the predetermined number of the occurrences of the time period is equal to or above a first predetermined threshold and if the accuracy of the speech recognition is within a predetermined accuracy range.

16. An apparatus for providing a user an interface to a voice application, the apparatus comprising:
a server having a processor and associated memory, wherein the server includes:
means for providing a user with an interface to access the application and to invoke one of a plurality of application services;
means for selecting an application service for the user, without the user requesting said application service, as a function of information representative of the user's past access to the application; and
means for providing the selected application service to the user.

17. An apparatus according to claim 16, wherein the information representative of the user's past access to the application includes an identifier associated with a service provided by the application.

18. An apparatus according to claim 16, wherein the information representative of the user's past access to the application includes a time that the user requested the service.

19. An apparatus according to claim 16, wherein the information representative of the user's past access to the application includes a date that the user requested the service.

20. An apparatus according to claim 16, wherein the information representative of the user's past access to the application includes a location where the user requested the service.

21. An apparatus according to claim 16, wherein the means for selecting an application service for the user comprises:
means for determining, for a predetermined number of occurrences of a time period, a number of times the user selected an application service during the predetermined number of the occurrences of the time period; and
means for selecting the application service if the number of times the user selected the application service during the predetermined number of the occurrences of the time period is equal to or above a predetermined threshold.

22. An apparatus according to claim 21, wherein the means for selecting an application service for the user comprises means for selecting an application service if a ratio of the number of times the user selected the application service during the predetermined number of occurrences of the time period to the number of times the user could have selected the application service during the predetermined number of occurrences of the time period is equal to or above a predetermined threshold.

23. An apparatus according to claim 21, wherein the server further includes, for each time period, means for counting more than one occurrence that the user selected the application service as only one occurrence.

24. An apparatus according to claim 21, wherein the server further includes:
means for creating a plurality of time periods wherein each day includes more than one time period.

25. An apparatus according to claim 21, wherein the server further includes:
means for creating a plurality of time periods wherein each week includes a weekday time period and a weekend time period.

26. An apparatus according to claim 25, wherein the means for creating a plurality of time periods further comprises means for creating a plurality of time periods wherein each day includes more than one time period.

27. An apparatus according to claim 24, wherein the server further includes:
means for ranking each of the patterns by priority such that if a user called at a time and a plurality of patterns correspond to the time, one of the plurality of patterns having a greatest priority is considered first.

28. An apparatus according to claim 16, wherein the server further includes:
means for allowing the user to view and modify the information about the input of the user.

29. A method for providing a user an interface to a voice application, the method comprising:
providing a user with an interface to access the application and to invoke one of a plurality of application services;
obtaining and storing information about a plurality of application services invoked by the user;
analyzing the information about a plurality of application services invoked by the user to determine a pattern of usage of one or more available application services;
selecting for the user an application service based upon the pattern of usage; and
providing the selected application service to the user.

30. A method according to claim 29, wherein selecting for the user an application service based upon the pattern of usage comprises selecting an application if a frequency with which the user invoked the application service is above a predetermined threshold.

31. A method according to claim 30, wherein the frequency is determined by dividing a number of times that the user invoked the application service during a predetermined number of occurrences of a time period by the predetermined number of occurrences of the time period.

32. A method according to claim 31, wherein the time period is within a day.

33. A method according to claim 29, wherein selecting for the user an application service based upon the pattern of usage comprises selecting an application if a frequency with which the user invoked the application service is more than a first predetermined threshold and a determined accuracy of a speech recognition of the user is within a predetermined accuracy range.

34. A method according to claim 29, wherein selecting for the user an application service based upon the pattern of usage comprises selecting an application if a frequency the user invoked the application service is less than a first predetermined threshold and a frequency one or more other users invoked the application service is above a second predetermined threshold.

35. A method according to claim 29, wherein selecting for the user an application service based upon the pattern of usage comprises selecting an application if a frequency the user invoked the application service at a predetermined location cluster is above a predetermined threshold.

36. An apparatus for using historical data of a user in a voice application, the method comprising:
a server having a processor and memory, wherein the server has code executed thereon programmed to:
provide a user with an interface to access the application and to invoke one of a plurality of application services;
obtain and store information about a plurality of application services invoked by the user;
analyze the information about a plurality of application services invoked by the user to determine a pattern of usage of one or more available application services;
select for the user an application service based upon the pattern of usage; and
provide the selected application service to the user.

37. An apparatus according to claim 36, wherein the code executed on the server that is programmed to select for the user an application service based upon the pattern of usage comprises code executed on the server programmed to select an application if a frequency the user invoked the application service is above a predetermined threshold.

38. An apparatus according to claim 37, wherein the frequency is determined by dividing a number of times that the user invoked the application service during a predetermined time period within a day by a number of times that the user could have invoked the application service in the predetermined time period.

39. An apparatus according to claim 37, wherein the frequency is determined by dividing a number of times that the user invoked the application service during one or more occurrences of a predetermined time period by a number of the one or more occurrences of the time period.

40. An apparatus according to claim 36, wherein the code executed on the server that is programmed to select for the user an application service based upon the pattern of usage comprises code executed on the server programmed to select an application if a frequency with which the user invoked the application service is greater than a first predetermined threshold and a determined accuracy of a speech recognition of the user is within a predetermined accuracy range.

41. An apparatus according to claim 36, wherein the code executed on the server that is programmed to select for the user an application service based upon the pattern of usage comprises code executed on the server programmed to select an application if a frequency the user invoked the application service is less than a first predetermined threshold and a frequency one or more other users invoked the application service is above a second predetermined threshold.

42. An apparatus according to claim 36, wherein the code executed on the server that is programmed to select for the user an application service based upon the pattern of usage comprises code executed on the server programmed to select an application if a frequency the user invoked the application service at a predetermined location cluster is above a predetermined threshold.

43. An article of manufacture, comprising:
a computer readable medium having computer readable program code for providing a user an interface to a voice application, the computer readable program code including instructions for:
causing the computer system to provide a user with an interface to access the application and to invoke one of a plurality of application services;
causing the computer system to obtain and store information about a plurality of application services invoked by the user;
causing the computer system to analyze the information about a plurality of application services invoked by the user to determine a pattern of usage of one or more available application services;
causing the computer system to select for the user an application service based upon the pattern of usage; and
causing the computer system to provide the selected application service to the user.

44. An article of manufacture according to claim 43, wherein the instructions for causing the computer system to select for the user an application service based upon the pattern of usage comprises instructions for causing the computer system to select an application if a frequency the user invoked the application service is above a predetermined threshold.

45. An article of manufacture according to claim 43, wherein the frequency is determined by dividing a number of times that the user invoked the application service during a predetermined time period over one or more days by a number of the one or more days.

46. An article of manufacture according to claim 43, wherein the frequency is determined by dividing a number of times that the user invoked the application service during one or more occurrences of a predetermined time period by a number of the one or more occurrences of the predetermined time period.

47. An article of manufacture according to claim 43, wherein the instructions for causing the computer system to select for the user an application service based upon the pattern of usage comprises instructions for causing the computer system to select an application if a frequency with which the user invoked the application service is greater than a first predetermined threshold and a determined accuracy of a speech recognition of the user is within a predetermined accuracy range.

48. An article of manufacture according to claim 43, wherein the instructions for causing the computer system to select for the user an application service based upon the pattern of usage comprises instructions for causing the computer system to select an application if a frequency the user invoked the application service is less than a first predetermined threshold and a frequency one or more other users invoked the application service is above a second predetermined threshold.

49. An article of manufacture according to claim 43, wherein the instructions for causing the computer system to select for the user an application service based upon the pattern of usage comprises instructions for causing the computer system to select an application if a frequency the user invoked the application service at a predetermined location cluster is above a predetermined threshold.

50. A method for providing a user an interface to a voice application, the method comprising the steps of:
providing a user with an interface to access the application and to invoke one of a plurality of application services;
selecting an application service for the user, without the user requesting said application service, as a function of information representative of other users' past access to the application; and
providing the selected application service to the user.

51. A method according to claim 50, wherein the information representative of the other users' past access to the application includes an identifier associated with a service provided by the application.

52. A method according to claim 50, wherein the information representative of the user's past access to the application includes a time that the user requested the service.

53. A method according to claim 50, wherein the information representative of the other users' past access to the application includes a date that the other users requested the service.

54. A method according to claim 50, wherein the step of selecting an application service for the user, comprises:
determining, for a predetermined number of occurrences of a time period, a number of times the other users selected an application service during the predetermined number of the occurrences of the time period; and
selecting the application service if the number of times the other users selected the application service during the predetermined number of the occurrences of the time period is equal to or above a predetermined threshold.
